(19) United States
(12) Patent Application Publication
(10) Pub. No.: US 2025/0386961 A1
(43) Pub. Date: Dec. 25, 2025

(54) SPOON ASSEMBLY FOR MIXING AND STIRRING WINE

(71) Applicant: WORLD LINK ARTICLE ENTERPRISE CO., LTD., Kaohsiung City (TW)

(72) Inventor: Hsing-Hui Chen, Kaohsiung City (TW)

(21) Appl. No.: 18/748,044

(22) Filed: Jun. 19, 2024

(51) Int. Cl. A47G 21/04; G01K 1/08

(52) U.S. Cl. CPC A47G 21/04; G01K 1/08

(57) ABSTRACT

A spoon assembly for mixing and stirring wine includes a stick, a funnel portion connected with a first end of the stick, and a spoon portion connected with a second end of the stick. The stick is hollow and has an elongate shape. The stick has a center formed with a passage penetrating the stick. The funnel portion has an inner space connected to the passage of the stick. The spoon portion and the funnel portion are opposite to each other. The spoon portion has a concave shape and is formed with a receiving space. The receiving space is connected to the passage of the stick.

### BACKGROUND OF THE INVENTION

### Field of the Invention

The present invention relates to a stirring spoon and, more particularly, to a spoon assembly for mixing and stirring wine or beverage used in a cocktail shaker for a fancy bartending show.

### Description of the Related Art

Bartending is made by mixing a variety of drinks, ingredients and alcoholic beverages, and is loved by many people. In addition to the unique flavor formed by the mixing of many different flavors of drinks, a fancy bartending show is also performed during the bartending process, which is the reason why bartending is so popular among the public. In current bartending, a swizzle stick is often used to stir and mix the prepared drinks. However, the existing swizzle stick has a solid rod structure so that the existing swizzle stick only has the function of stirring drinks and is not available for a fancy bartending show, thereby limiting the versatility of the conventional swizzle stick.

### BRIEF SUMMARY OF THE INVENTION

The primary objective of the present invention is to provide a spoon assembly for mixing and stirring wine to perform a fancy bartending action.

In accordance with the present invention, there is provided a spoon assembly comprising a stick, a funnel portion connected with a first end of the stick, and a spoon portion connected with a second end of the stick. The stick is hollow and has an elongate shape. The stick has a center formed with a passage penetrating the stick. The funnel portion has an inner space connected to the passage of the stick. The spoon portion and the funnel portion are opposite to each other. The spoon portion has a concave shape and is formed with a receiving space. The receiving space is connected to the passage of the stick.

According to the primary advantages of the present invention, the drinks are poured into the funnel portion, then flow through the passage of the stick into the receiving space of the spoon portion, to facilitate the user or bartender performing a fancy bartending show, and to enhance the versatility of the spoon assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a spoon assembly in accordance with the preferred embodiment of the present invention.

FIG. 2 is another perspective view of the spoon assembly in accordance with the preferred embodiment of the present invention.

FIG. 3 is a cross-sectional view of the spoon assembly as shown in FIG. 1.

FIG. 4 is an exploded front view of a spoon assembly in accordance with a second preferred embodiment of the present invention.

FIG. 5 is a locally cross-sectional assembly view of the spoon assembly as shown in FIG. 4.

### DETAILED DESCRIPTION OF THE INVENTION

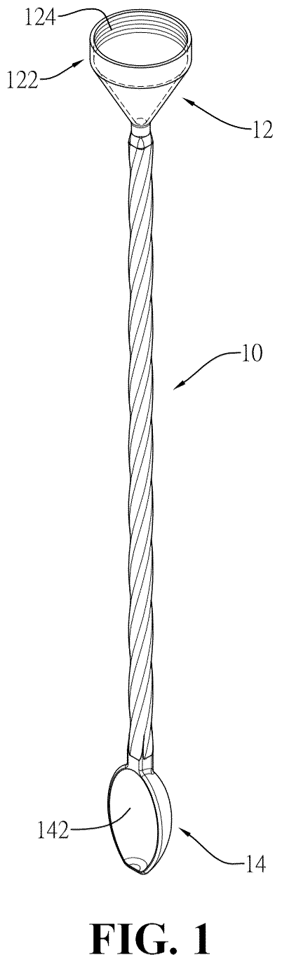

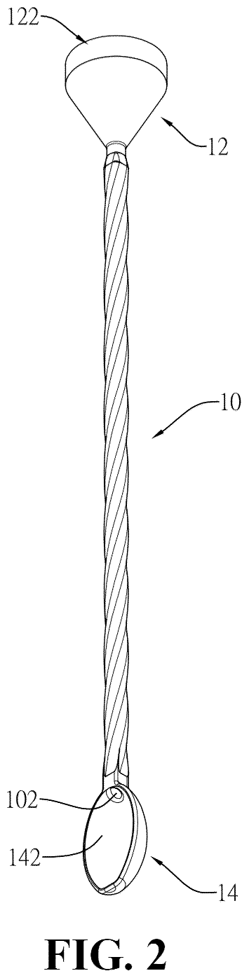

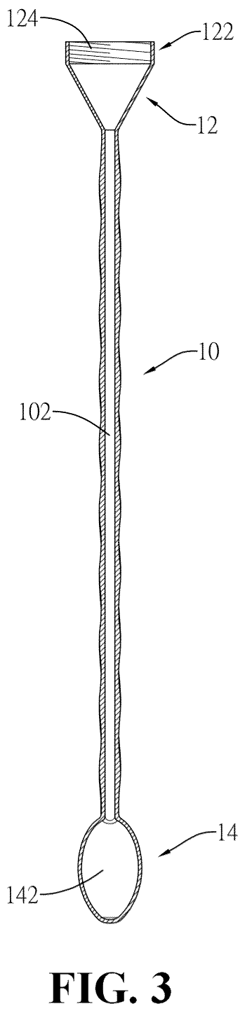

Referring to the drawings and initially to FIGS. 1-3, a spoon assembly for mixing and stirring wine in accordance with the preferred embodiment of the present invention comprises a stick 10, a funnel portion 12 connected with a first end of the stick 10, and a spoon portion 14 connected with a second end of the stick 10. The stick 10 is hollow and has an elongate shape. The stick 10 has a center formed with a passage 102 penetrating the stick 10. The funnel portion 12 has an inner space connected to the passage 102 of the stick 10. The funnel portion 12 has an opening directed upward and expanded gradually. The spoon portion 14 and the funnel portion 12 are opposite to each other. The spoon portion 14 has a concave shape and is formed with a receiving space 142. The receiving space 142 is connected to the passage 102 of the stick 10.

In the preferred embodiment of the present invention, the funnel portion 12 and the stick 10 are formed and combined integrally.

In another preferred embodiment of the present invention, the funnel portion 12 and the stick 10 are connected by screwing.

In practice, different beverages or ingredients are poured into the funnel portion 12, then flow through the passage 102 of the stick 10 into the receiving space 142 of the spoon portion 14, and finally flow into a cocktail shaker to mix with the wine. In such manner, the beverages of different colors are mixed with the wine to facilitate the user or bartender performing a fancy bartending show. Thus, the spoon assembly has a function of mixing and stirring the wine and has an effect of performing a fancy bartending show, to enhance the versatility of the spoon assembly.

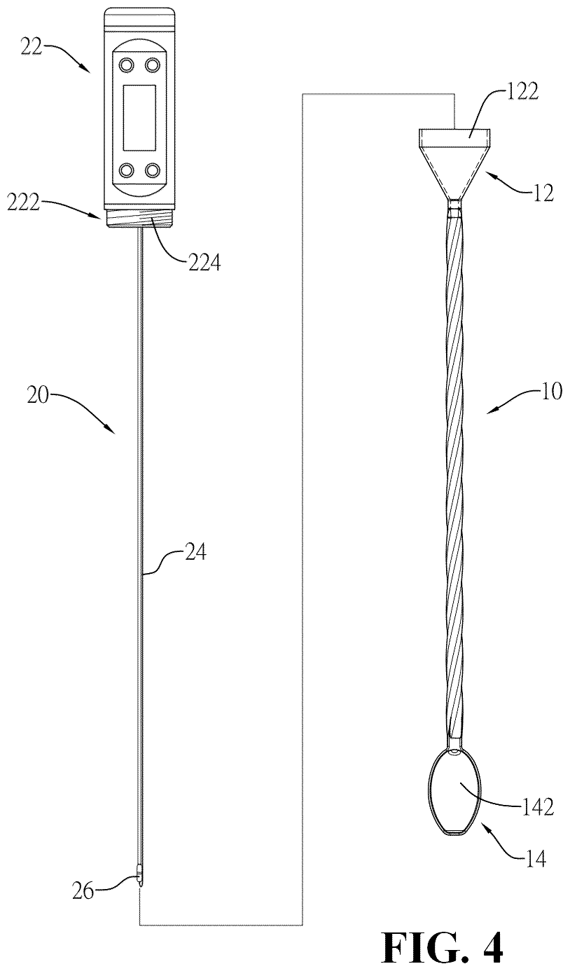

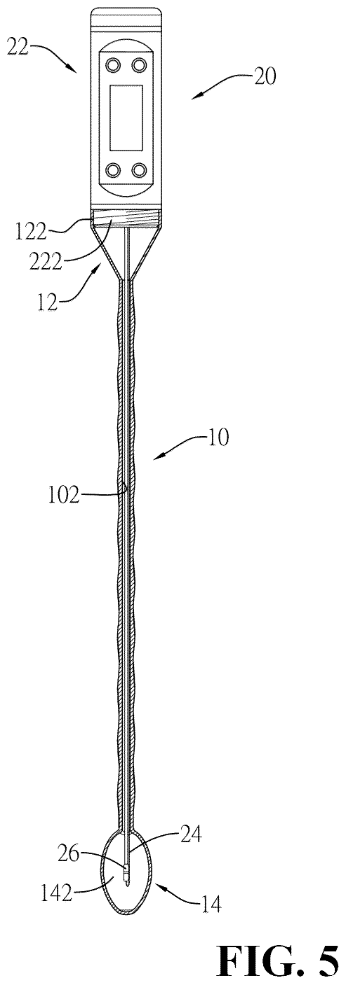

Referring to FIGS. 4 and 5 with reference to FIGS. 1-3, the spoon assembly further comprises a thermometer 20 combined with the funnel portion 12. The funnel portion 12 has an end formed with a first connecting section 122. The thermometer 20 is detachably connected with the first connecting section 122. The thermometer 20 includes a main body 22, a wire (or lead) 24 having a first end connected with the main body 22, and a temperature detector 26 connected with a second end of the wire 24. The main body 22 indicates a temperature detected by the temperature detector 26. The main body 22 and the temperature detector 26 are opposite to each other. The main body 22 is provided with a second connecting section 222 combined with the first connecting section 122 of the funnel portion 12. The wire 24 and the temperature detector 26 pass through the passage 102 of the stick 10 and extend into the receiving space 142 of the spoon portion 14.

In the preferred embodiment of the present invention, the first connecting section 122 of the funnel portion 12 is formed with an internal thread 124, and the second connecting section 222 of the main body 22 of the thermometer 20 is formed with an external thread 224 screwed into the internal thread 124 of the funnel portion 12.

In practice, when the spoon assembly is used for mixing and stirring the wine, the temperature detector 26 is used to detect the temperature of the wine. Thus, the user or bartender adds ice cubes into the cocktail shaker to adjust the temperature of the wine to the optimum value to ensure the best taste when drinking the cocktail.

In another preferred embodiment of the present invention, the first connecting section 122 of the funnel portion 12 is formed with an external thread, and the second connecting section 222 of the main body 22 of the thermometer 20 is formed with an internal thread screwed onto the external thread of the funnel portion 12.

In another preferred embodiment of the present invention, the first connecting section 122 of the funnel portion 12 is formed with a snap-fit block, and the second connecting section 222 of the main body 22 of the thermometer 20 is formed with a snap-fit hole combined with the snap-fit block of the funnel portion 12.

Accordingly, the drinks are poured into the funnel portion 12, then flow through the passage 102 of the stick 10 into the receiving space 142 of the spoon portion 14, to facilitate the user or bartender performing a fancy bartending show, and to enhance the versatility of the spoon assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A spoon assembly comprising:
a stick;
a funnel portion connected with a first end of the stick; and
a spoon portion connected with a second end of the stick;
wherein:
the stick is hollow and has an elongate shape;
the stick has a center formed with a passage penetrating the stick;
the funnel portion has an inner space connected to the passage of the stick;
the spoon portion and the funnel portion are opposite to each other;
the spoon portion has a concave shape and is formed with a receiving space; and
the receiving space is connected to the passage of the stick.

2. The spoon assembly as claimed in claim 1, wherein the funnel portion and the stick are formed and combined integrally.

3. The spoon assembly as claimed in claim 1, further comprising:
a thermometer combined with the funnel portion.

4. The spoon assembly as claimed in claim 3, wherein the funnel portion has an end formed with a first connecting section, and the thermometer is detachably connected with the first connecting section.

5. The spoon assembly as claimed in claim 4, wherein:
the thermometer includes a main body, a wire having a first end connected with the main body, and a temperature detector connected with a second end of the wire;
the main body indicates a temperature detected by the temperature detector;
the main body and the temperature detector are opposite to each other;
the main body is provided with a second connecting section combined with the first connecting section of the funnel portion; and
the wire and the temperature detector pass through the passage of the stick and extend into the receiving space of the spoon portion.

6. The spoon assembly as claimed in claim 5, wherein the first connecting section of the funnel portion is formed with an internal thread, and the second connecting section of the main body of the thermometer is formed with an external thread screwed into the internal thread of the funnel portion.

7. The spoon assembly as claimed in claim 1, wherein the funnel portion has an end formed with a first connecting section, and the thermometer is detachably connected with the first connecting section.

8. The spoon assembly as claimed in claim 7, wherein:
the thermometer includes a main body, a wire having a first end connected with the main body, and a temperature detector connected with a second end of the wire;
the main body indicates a temperature detected by the temperature detector;
the main body and the temperature detector are opposite to each other;
the main body is provided with a second connecting section combined with the first connecting section of the funnel portion; and
the wire and the temperature detector pass through the passage of the stick and extend into the receiving space of the spoon portion.

9. The spoon assembly as claimed in claim 8, wherein the first connecting section of the funnel portion is formed with an internal thread, and the second connecting section of the main body of the thermometer is formed with an external thread screwed into the internal thread of the funnel portion.
